(19) United States
(12) Patent Application Publication
(10) Pub. No.: US 2009/0039715 A1
(43) Pub. Date: Feb. 12, 2009

(54) OSCILLATOR DEVICE, OPTICAL DEFLECTOR AND OPTICAL INSTRUMENT USING THE SAME

(75) Inventors: Kaoru Noguchi, Tokyo (JP); Koichi Hara, Hadano-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/186,896

(22) Filed: Aug. 6, 2008

(30) Foreign Application Priority Data
Aug. 7, 2007 (JP) 2007-204849

(51) Int. Cl. H02K 33/00; G02B 26/08

(52) U.S. Cl. 310/36; 359/224

(57) ABSTRACT

An oscillator device includes an oscillator supported for oscillatory motion about an oscillation central axis, a magnetic member provided on the oscillator, and a magnetic-field generating member disposed opposed to the oscillator, wherein the magnetic member is provided at a side portion sandwiched between a top surface and a bottom surface of the oscillator.

### FIELD OF THE INVENTION AND RELATED ART

This invention relates to an oscillator device having an oscillator supported for oscillation around an oscillation central axis, an optical deflector, and an optical instrument such as an image forming apparatus using the same.

Image forming apparatuses such as a copying machine or a laser beam printer, optical instruments such as a bar code reader or the like, and optical instruments such as a visual display unit in which a laser beam is scanned to project an image, use an optical scanner (optical deflector).

Generally, for optical scanners which mechanically perform optical scanning, a polygon mirror comprising a rotary polygonal mirror and a galvano mirror comprising an oscillation type reflecting mirror are known. Particularly, in the galvano mirror type scanners, resonance type optical scanners based on a silicon substrate have been developed through micromechanics techniques. This will enable reduction in size, weight and cost, and image forming apparatuses using such a resonance type optical scanner have been proposed.

A prior art example of optical deflector satisfying these is the one disclosed in Japanese Laid-Open Patent Application No. 06-82711. FIG. 6 is a perspective view which shows an optical deflector of this example. The optical deflector comprises a magnetism generating member 2 having an electric coil 2a, and a planner scanning mirror 1. The scanning mirror 1 is driven while being angularly displaced in response to the magnetism of the magnetism generating member 2 caused by energizing the electric coil 2a, so that the light reflected by the mirror surface portion 1b is scanned. The scanning mirror 1 is supported at its opposite ends by a supporting member 1d, for angular displacement about the driving axis 1e that connects the opposite end portions. Furthermore, one side of the scanning mirror 1 is defined by the mirror surface member 1b, while the other side is defined by a thin film-shaped permanent magnet 1c being polarized by different poles at both sides of the driving axis 1e. In the magnetism generating member 2, a direction orthogonal to the driving axis 1e of the scanning mirror 1 is made coincident with the winding axis of the electric coil 2a. Additionally, it is provided at the other side of the scanning mirror 1, with a predetermined distance maintained therebetween. Thus, the scanning mirror 1 can be driven alone in the light-weight state, having only the thin-film permanent magnet 1c provided on the other side. Therefore, even if the scanning mirror 1 is made large in size, it can be easily driven by a comparatively small driving force.

However, the optical deflector described above has the following inconveniences. That is, if the center of the torsional torque generated in the permanent magnet 1c deviates from the driving axis 1e defined by the supporting member 1d, transverse vibration may occur in the scanning mirror 1. It this occurs, stable torsional oscillation about the driving shaft 1e is not attained, and the operational stability is disturbed.

### SUMMARY OF THE INVENTION

The present invention in an aspect thereof provides an oscillator device, comprising: an oscillator supported for oscillatory motion about an oscillation central axis; a magnetic member provided on said oscillator; and a magnetic-field generating member disposed opposed to said oscillator; wherein said magnetic member is provided at a side portion sandwiched between a top surface and a bottom surface of said oscillator.

In one preferred form of this aspect of the present invention, the magnetic member is provided at a side portion sandwiched between the top surface and the bottom surface of said oscillator and at a portion intersecting with the oscillation central axis.

The oscillator device may comprise a plurality of said oscillators and a plurality of torsion springs, and said oscillators and said torsion springs may be disposed on a straight line along the oscillation central axis.

The gravity center of said magnetic material may be disposed on the oscillation central axis of said oscillator.

The magnetic member may have a cylindrical shape, and wherein the side portion of said oscillator has a recess.

The magnetic member may be comprised of a permanent magnet, and the magnetic-field generating member may be comprised of an electric coil.

In accordance with another aspect of the present invention, there is provided an optical deflector, comprising: an oscillator device as recited above; and a light reflecting member provided on one oscillator.

In accordance with another aspect of the present invention, there is provided an oscillator device, comprising: a supporting member; a first resilient support member configured to connect a first oscillator and said supporting member each other and to support said first oscillator for oscillatory motion about an oscillation central axis; a second resilient support member configured to connect the first oscillator and a second oscillator each other and to support said second oscillator for oscillatory motion about the oscillation central axis; a magnetic member provided on said first oscillator; and a magnetic-field generating member disposed opposed to said first oscillator; wherein said magnetic member is provided at a side portion sandwiched between a top surface and a bottom surface of said first oscillator.

In accordance with a further aspect of the present invention, there is provided an optical instrument, comprising: a light source; an optical deflector as recited above; and a target member on which light is to be incident; wherein said optical deflector is configured to deflect light from said light source and to project at least a portion of the light onto said target member.

In accordance with the present invention, since the magnetic member is provided at the side portion of the oscillator, even if the magnetic member is made large, the gravity center of the oscillator deviates little from the oscillation central axis. Furthermore, the center of the torque produced in the magnetic member deviates little from the oscillation central axis. Therefore, the oscillator can oscillate stably about the oscillation central axis.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1A is a top plan view for explaining a first embodiment of an optical deflector using an oscillator device according to the present invention.

FIG. 1B and FIG. 1C are sectional views, respectively, for explaining different portions of the first embodiment of the present invention.

FIG. 1D is a sectional view for explaining the oscillation method.

FIG. 1E is a sectional view of another example of the side portion where a magnetic member is provided.

FIG. 2A and FIG. 2B are diagrams for explaining transverse vibration of the oscillator when the gravity center of the magnet and the oscillation central axis are not aligned each other, wherein FIG. 2A is a schematic diagram when the gravity center of the magnet and the oscillation central axis are aligned each other, and FIG. 2B is a schematic diagram when the gravity center of the magnet and the oscillation central axis are not aligned each other.

FIG. 3A is a top plan view for explaining a second embodiment of an optical deflector using an oscillator device according to the present invention.

FIG. 3B and FIG. 3C are sectional views, respectively, for explaining different portions of the second embodiment of the present invention.

FIG. 4 is a top plan view for explaining a third embodiment of an optical deflector using an oscillator device according to the present invention.

FIG. 5 is a diagram for explaining an optical instrument according to a fourth embodiment of the present invention.

FIG. 6 is a diagram for explaining the background art of the present invention.

### DESCRIPTION OF THE PREFERRED EMBODIMENTS

Preferred embodiments of an oscillator device, an optical deflector and an optical instrument using the same, according to the present invention, will now be described with reference to the attached drawings.

### First Embodiment

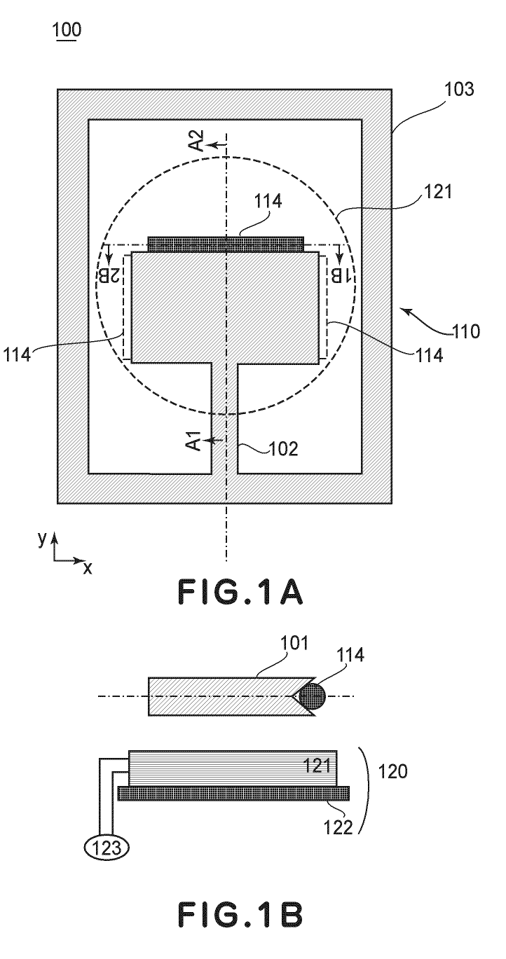

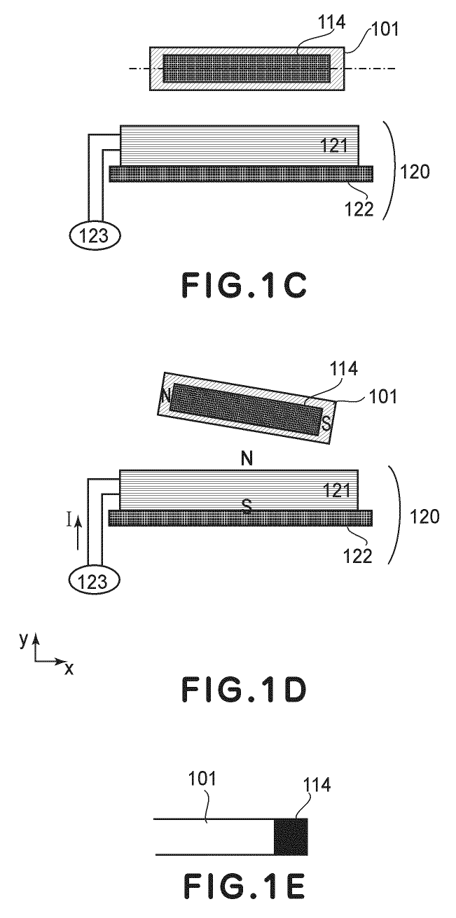

Referring to several drawings, the structure of an optical deflector 100 according to a first embodiment, using an oscillator device of the present invention, will be explained. FIG. 1A is a top plan view thereof, and FIG. 1B is a sectional view taken along a line A1-A2 in FIG. 1A. As shown in these drawings, the optical deflector 100 comprises a structure in which a tip portion 110 made through MEMS technique and an electromagnetic coil member 120, constituting a driving mechanism, are installed on a jig (not shown). With regard to the size of the structure, for example, it is about 5 mm in length, about 5 mm in width and around 3 mm in height.

The tip portion 110 will be explained in detail with reference to FIG. 1A and FIG. 1B. In these drawings, for better understanding, the size and the relative ratio are illustrated with exaggeration or modification. The tip portion 110 is comprised of an oscillator 101 supported for oscillation, a torsion spring 102 which is a resilient support member, and a supporting member 103 which is a support. The oscillator 101 is supported by the supporting member 103 through the torsion spring 102, and the supporting member 103 is fixed to a jig. The oscillator 101 is supported for oscillation about an oscillation central axis (extending in the direction of a line A1-A2 in FIG. 1A) defined by the torsion spring 102.

The oscillator 101, torsion spring 102 and supporting member 103 are formed integrally from a substrate having a thickness of around 300 microns. The substrate consists of monocrystal silicon, for example. Since the monocrystal silicon has superiority in mechanical characteristics such as large Young's modulus, small specific gravity and little plastic deformation, the oscillator 101 can have a large resonance frequency.

The oscillator 101 is provided with a light reflecting member formed on the surface thereof. This reflecting member is made of aluminum, for example. This reflecting member of the oscillator 101 functions as an optical deflection element of the optical deflector 100.

The oscillator 101 is provided with a permanent magnet 114 which is a magnetic member of cylindrical shape. The magnet is disposed at the side portion sandwiched between the surface of the oscillator including the reflecting member thereof and the bottom surface thereof, and also at the portion intersecting with the oscillation central axis (i.e., at the side surface perpendicular to the oscillation central axis, in the illustrated example). In this embodiment, this side portion has a recessed shape. In the illustrated example, the recess has a triangular column-like shape as shown in FIG. 1B. However, the recess may have a sectional shape of trapezoid or rectangle. In the case of triangular column-like shape, when the permanent magnet 114 of cylindrical shape is placed there, it can be aligned easily and precisely. Furthermore, no recess may be provided and the surface may be flat. In that occasion, as shown in FIG. 1E, if a permanent magnet 114 of prism-like shape is placed there, it can be aligned easily and precisely. The positioning of the permanent magnet 114 in the longitudinal direction can be fixed by, for example, making the length of the side portion in the direction orthogonal to the oscillation central axis and the length of permanent magnet 114 equal to each other and by registering the end portions of them. Alternatively, the positioning of the permanent magnet 114 in the longitudinal direction can be made while observing it through a monitor.

The permanent magnet 114 which is a magnetic member is made of a material provided by polarizing a hard magnetic material such as samarium cobalt or neodymium iron boron, for example. The permanent magnet 114 may have various shapes other than the cylindrical shape. The polarity of the permanent magnet 114 is such that, as shown in FIG. 1D, there are an N pole and an S pole sandwiching the oscillation central axis defined by the torsion spring 102. With regard to the polarity, the N pole and the S pole illustrated may be reversed.

In this embodiment, the oscillator 101 has a tabular and rectangular shape as illustrated, and the magnetic member is provided at the side portion thereof as mentioned above in the manner that the gravity center thereof is aligned with the oscillation central axis (that is, it is set on the oscillation central axial). However, the shape of the oscillator is not limited to this. For example, it may be triangle, polygon, circular or elliptical. The magnetic member may be placed at a suitable side portion of the oscillator of such shape. In summary, the oscillator may have any shape, provided that it easily allows that the gravity center of the magnetic member is placed on the oscillation central axial. Furthermore, two or more magnetic members may be provided, while the gravity center of each magnetic member should be aligned with the oscillation central axis.

The electromagnetic coil member 120 will be explained furthermore. In this embodiment, the electromagnetic coil member 120 is comprised of an electromagnetic coil 121 and an electromagnetic coil substrate 122. The electromagnetic coil 121 has its electric wirings wounded in a circular shape along the X-Y plane. In response to an electric power supplied from a power source 123, an N pole or S pole appears at the top surface or the bottom surface of the electromagnetic coil 121, depending on the direction of the electric current. The electric wirings of the electromagnetic coil 121 are made of a low-resistance metal such as copper or aluminum, and the number of turns (windings) is from several ten times to several hundred times. With regard to the size of the electromagnetic coil 124, the diameter is d=3 mm and the height is t=2 mm, for example. The magnetic coil substrate 122 is made of a ferromagnetic material such as iron or Permalloy (registered trademark). It has a function for supporting the electromagnetic coil 121 and a function for intercepting the magnetic field produced from the electromagnetic coil 121 at the position of the substrate 122, thereby to concentrate the magnetic field upwardly.

Next, the oscillation method of the oscillator 101 will be explained. FIG. 1D shows the state in which an electric current I flows into the electromagnetic coil 121 and the N pole appears at the top surface of the electromagnetic coil 121. The magnetic field H produced there is proportional to the product of the current I flowing through the electromagnetic coil 121 with the number of turns N of the electromagnetic coil 121. The magnetic field H acts on the magnetic pole of the permanent magnet 114, so that the torsion spring 102 deforms around the oscillation central axis and thus the oscillator 101 is displaced. By using an alternating current for the current I, the oscillator 101 can be displaced periodically. Furthermore, if the frequency of the alternating current and the resonance frequency of the oscillator 101 are made approximately equal to each other, oscillatory displacement of the oscillator 101 can be accomplished by low power consumption. It should be noted here that the permanent magnet may be replaced by a soft magnetic material. However, in that occasion, only an attraction force acts between the electromagnetic coil and the soft magnetic material. Therefore, it is necessary to dispose the electromagnetic coil and the soft magnetic material to meet this. For example, a couple of electromagnetic coils may be provided at a position opposed to the portion of the soft magnetic material at a side of symmetrical positions across the oscillation central axis, an electric current may be alternately applied to the two electromagnetic coils, to cause the oscillator to produce oscillatory motion about the oscillation central axis. In this case, two soft magnetic materials may be provided at the side portion at symmetrical positions across the oscillation central axis, in the manner that the gravity center thereof is placed on the oscillation central axial. An example is illustrated by a broken line shown at 114 in FIG. 1A. Furthermore, the magnetic-field generating means may comprise, other than the electromagnetic coil, a permanent magnet which is rotationally driven to modulate the magnetic field acting on the magnetic member, a combination of a magnetic shielding shutter and a permanent magnet similarly driven to modulate the magnetic field.

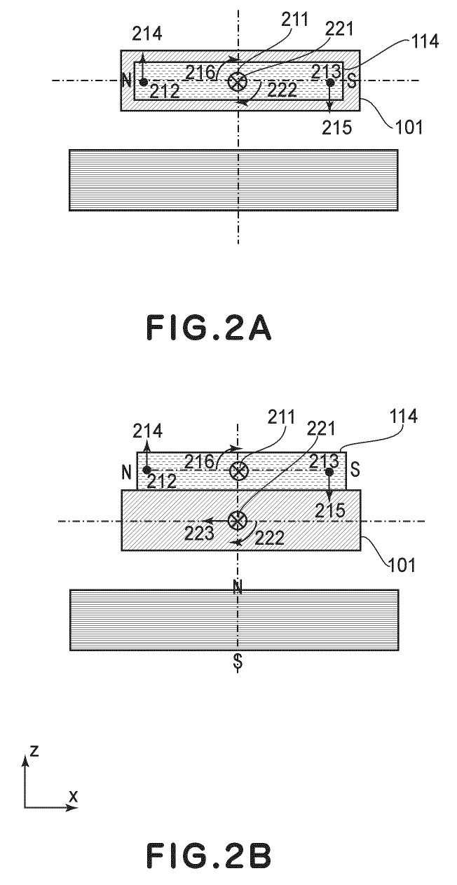

Here, the transverse vibration of the oscillator 101 which is produced when the gravity center of the permanent magnet 114 and the oscillation central axis are not aligned each other, will be explained with reference to FIG. 2A and FIG. 2B. FIG. 2A and FIG. 2B schematically illustrate the oscillator 101 along the B1-B2 section of FIG. 1A.

FIG. 2A shows the case where the gravity center 211 of the permanent magnet 114 and the oscillation central axis 221 are aligned each other. The present embodiment is based on this. When an even external magnetic field is applied to the oscillator 101, forces 214 and 215 are produced at both poles 212 and 213 of the permanent magnet 114, respectively, and thus a torsional torque 216 about the gravity center 211 is generated. Here, since the gravity center 211 of permanent magnet 114 and the oscillation central axis 221 of the oscillator 101 are aligned, only a torsional torque 222 about the oscillation central axis 221 is applied to the oscillator 101. In this way, the oscillator 101 produces idealistic oscillatory motion about the oscillation central axis 221.

On the other hand, FIG. 2B illustrates a case where the gravity center 211 of the permanent magnet 114 adhered to the surface of the oscillator 101 and the oscillation central axis 221 are not aligned with each other. When an even external magnetic field is applied to the oscillator 101, a torsional torque 216 about the gravity center 211 of the permanent magnet 114 is produced. Here, since the gravity center 211 of the permanent magnet 114 and the oscillation central axis 221 are not aligned, a force 223 in the X-direction is applied to the oscillator 101, in addition to the torsional torque 222 about the oscillation central axis 221. As a result, transverse vibration in the X-direction occurs in the oscillator 101, in addition to the idealistic oscillatory motion about the oscillation central axis 221.

In this embodiment, the permanent magnet 114 is disposed at the side portion of the oscillator 101. Therefore, the permanent magnet 114 can be easily disposed to be symmetrical with respect to the oscillation central axis 221. Namely, the permanent magnet 114 is so disposed that the gravity center 124 of the permanent magnet 114 coincides with the oscillation central axis 221 and, by doing it this way, the transverse vibration is suppressed and stable torsional oscillation of the oscillator 101 is assured for a long time.

In accordance with the present embodiment, the magnetic member is provided at a side portion sandwiched between the surface of the oscillator having a reflecting member and the bottom surface thereof and also at a portion intersecting with the oscillation central axis. Therefore, even if the magnetic member is made large, the gravity center of the oscillator does not largely deviate from the oscillation central axis, such that the gravity center of the oscillator can be easily placed on the oscillation central axial. Therefore, the center of the torque produced in the magnetic member does not deviate from the oscillation central axis, and thus the oscillator can provide stable oscillation about the oscillation central axis. Hence, stable torsional oscillation is assured for a long time.

Furthermore, in this embodiment, the magnetic member is comprised of a permanent magnet and the magnetic-field generate means is comprised of an electromagnetic coil. Hence, it is not necessary to supply the electric power into the oscillator from the outside, and it is not necessary to provide electric wirings for the supporting member, torsion spring and oscillator. Therefore, the supporting member, torsion spring and oscillator can be made more easily and inexpensively.

Furthermore, in this embodiment, the magnetic member has a cylindrical shape. Since the side portion sandwiched between the surface of the oscillator having a reflecting member and the bottom surface thereof has a recess, the self-alignment function can be added. In this way, the alignment of the magnetic member can be accomplished more easily and precisely and, therefore, the oscillator and the magnetic member can be installed more easily and precisely.

Furthermore, in this embodiment, since the supporting member, torsion spring and oscillator are integral and made of silicon, the supporting member, torsion spring and oscillator can be produced based on semiconductor processes. Therefore, the supporting member, torsion spring and oscillator can be manufactured easily and precisely.

Furthermore, in this embodiment, since the magnetic member is provided at the side portion sandwiched between the surface of the oscillator having a reflecting member and the bottom surface thereof, it can be used also as a double sided mirror as well.

### Second Embodiment

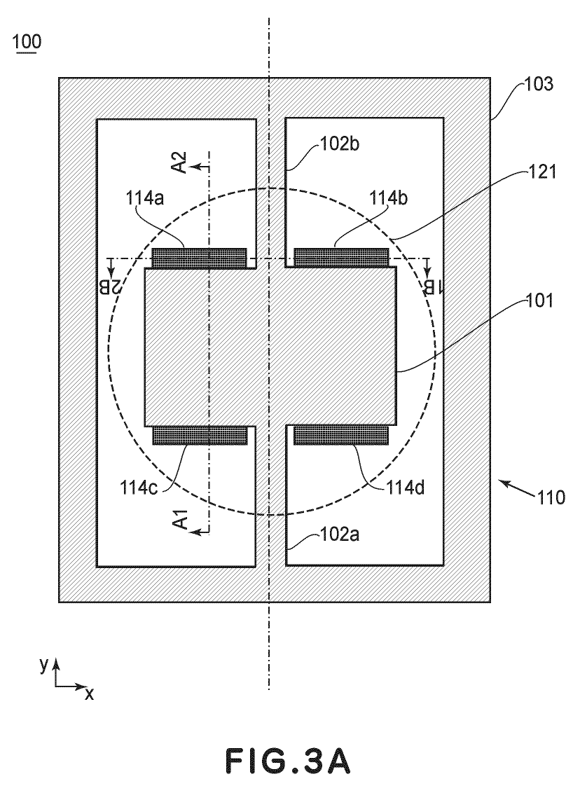

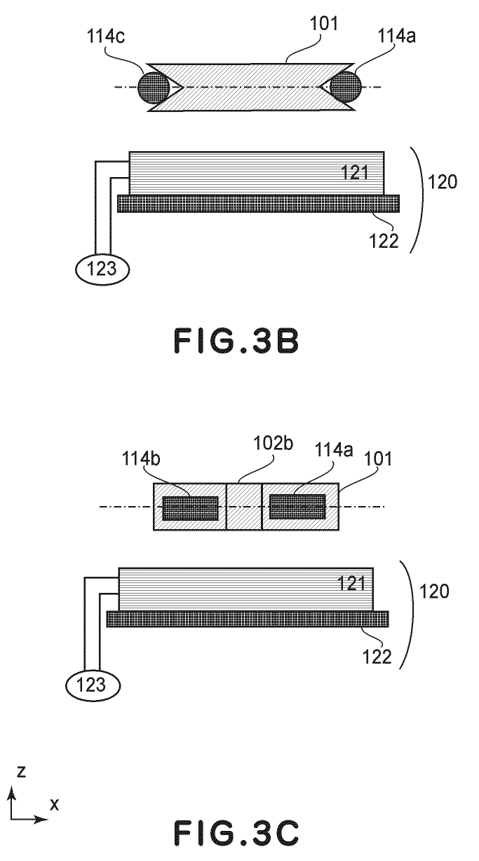

Next, the structure of an optical deflector 100 according to a second embodiment using an oscillator device of the present invention, will be explained with reference to the drawings. FIG. 3A is a top plan view of the optical deflector. Sectional views taken along a line A1-A2 and a line B1-B2 in FIG. 3A are shown in FIG. 3B and FIG. 3C, respectively. The basic structure, driving method, operational effects are similar to the abovementioned first embodiment. Description of corresponding portions will be omitted here, although they are illustrated in the diagrams.

The second embodiment differs from the first embodiment in that: the first embodiment concerns a structure in which the torsion spring is supported at one end; whereas the second embodiment concerns a structure in which the torsion spring is supported at its opposite ends. In the case of a torsion spring supported at one end, use of a single permanent magnet 114 easily enables alignment between the gravity center of the permanent magnet 114 and the oscillation central axis. On the other hand, in the case of a torsion spring supported at its opposite ends, when plural permanent magnets 114 are used, the misalignment between the gravity center of the permanent magnet 114 and the oscillation central axis can be made comparatively small. In the structure shown in FIGS. 3B and 3C, two pairs (i.e., four) permanent magnets 114 are provided at the side portion sandwiched between the opposite surfaces of the oscillator.

### Third Embodiment

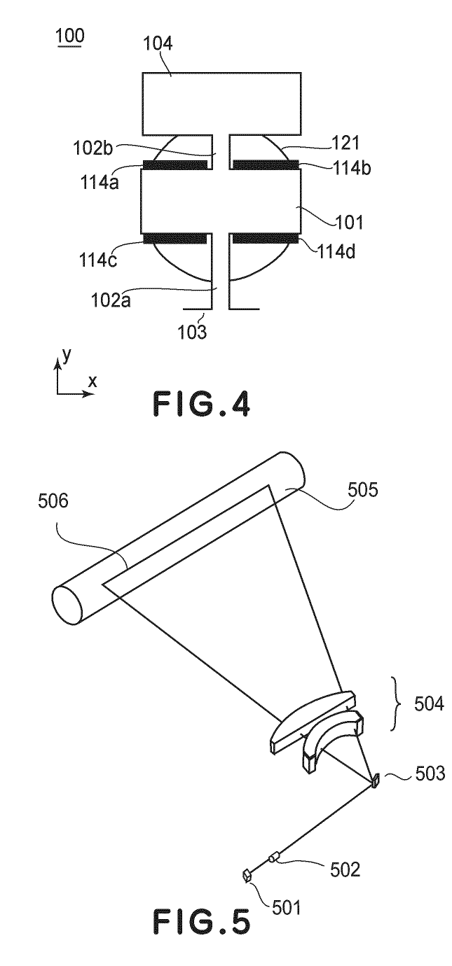

Next, the structure of an optical deflector 100 according to a third embodiment using an oscillator device of the present invention, will be explained with reference to the drawings. FIG. 4 is a top plan view of the optical deflector. The basic structure, driving method, operational effects are similar to the abovementioned first embodiment. Description of corresponding portions will be omitted here, although they are illustrated in the diagrams.

In this embodiment, the optical deflector 100 comprises a first oscillator 101 and a passive oscillator 104 which is a second oscillator, that is, an oscillator having a reflecting member. There are permanent magnets 114a-104d which are placed only at the side portion of the first oscillator 101. More specifically, the oscillator device (optical deflector) of the present invention comprises a supporting member, a first resilient support member for connecting the first oscillator and the supporting member each other and for supporting the first oscillator for oscillatory motion around the oscillation central axis, a second resilient support member for connecting the first oscillator and the second oscillator each other and for supporting the second oscillator for oscillatory motion about the oscillation central axis, a magnetic member provided at the first oscillator, and magnetic-field generating means disposed opposed to the first oscillator. The magnetic member is provided at the side portion sandwiched between the top surface and the bottom surface of the first oscillator.

Stating it in another way, the oscillator device comprise plural oscillators 101 and 104 and plural torsion springs 102a and 102b, and these oscillators and torsion springs are placed on a straight line along the oscillation central axis. Then, at least one of the plural oscillators 101 and 104 is not provided with a magnetic member. In such a structure, although the passive oscillator 104 does not receive the function of the magnetic field produced by the magnetic coil 121, it oscillates passively in response to the oscillatory motion of the oscillator 101. The passive oscillator 104 having no magnetic member avoids the possibility of contamination or damage of the reflecting member during installation of the permanent magnet 114. Furthermore, the passive oscillator 104 enables higher-performance operation (e.g., constant angular-speed motion which easily enables constant speed scan of the light beam deflected by the reflection surface formed on that oscillator) as well as stable operation. Furthermore, it enables oscillation of the oscillator 101 and the passive oscillator 104 even at different resonance frequencies.

In this embodiment, the oscillator device uses plural oscillators and plural torsion springs. This enables that plural oscillators are driven in separate oscillation modes simultaneously. Thus, a new function can be added to the oscillator. In this way, the performance of the oscillator is improved, such that a higher-performance oscillator device can be provided.

### Fourth Embodiment

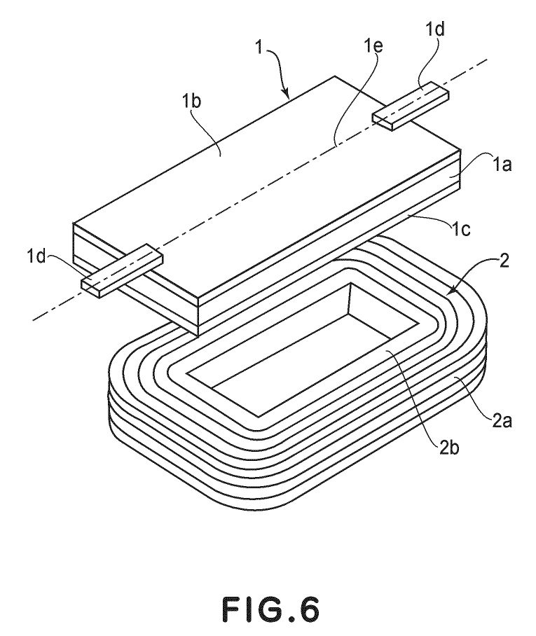

FIG. 5 is a diagram showing an embodiment of an optical instrument using an optical deflector based on an oscillator device of the present invention. Here, an image forming apparatus is shown as the optical instrument. In FIG. 5, denoted at 503 is the optical deflector of the present invention which is arranged, in the present embodiment, to scanningly deflect an incident light beam one-dimensionally. Denoted at 501 is a laser source. Denoted at 502 is a lens or lens group. Denoted at 504 is a writing lens or lens group. Denoted at 505 is a photosensitive member which is the target on which the light beam should be incident. Denoted at 506 is a scan locus.

The laser beam projected from the laser source 501 undergoes predetermined intensity modulation related to the timing of the scanning deflection of the light, and then it is scanningly deflected one-dimensionally by the optical deflector 503. By the function of the writing lens 504, the thus scanned laser beam forms an image on the photosensitive member 505 which is rotating at a constant speed around the rotational center. The photosensitive member 505 is uniformly electrically charged by a charging device (not shown). Thus, when it is scanned with light, an electrostatic latent image is formed on the scanned portion. Subsequently, a toner image is formed on the image portion of the electrostatic latent image by means of a developing device (not shown). This toner image is transferred to a paper sheet (not shown) and fixed thereon, by which an image is produced on the paper sheet.

With the optical deflector of the present invention, the angular speed of the scanning deflection of the light can be made approximately constant angular speed within a specified range. Furthermore, with the use of the optical deflector of the present invention having a reflecting member formed at the oscillator, stable scanning operation is assured for a long time. Thus, with the use of a structure including a light source and an optical deflector for deflecting light from the light source and by projecting at least a portion of light, deflected by the optical deflector, onto an image forming member, stable image formation is assured for a long time.

An optical deflector which is comprised of an oscillator device of the present invention can be incorporated into a visual display unit. In that occasion, the optical deflector deflects the light from a light source and directs at least a portion of the light onto an image display member which is the target on which the light should be incident.

While the invention has been described with reference to the structures disclosed herein, it is not confined to the details set forth and this application is intended to cover such modifications or changes as may come within the purposes of the improvements or the scope of the following claims.

This application claims priority from Japanese Patent Application No. 2007-204849 filed Aug. 7, 2007, for which is hereby incorporated by reference.

What is claimed is:

1. An oscillator device, comprising:
an oscillator supported for oscillatory motion about an oscillation central axis;
a magnetic member provided on said oscillator; and
a magnetic-field generating member disposed opposed to said oscillator;
wherein said magnetic member is provided at a side portion sandwiched between a top surface and a bottom surface of said oscillator.

2. An oscillator device according to claim 1, wherein said magnetic member is provided at a side portion sandwiched between the top surface and the bottom surface of said oscillator and at a portion intersecting with the oscillation central axis.

3. An oscillator device according to claim 1, wherein said oscillator device comprises a plurality of said oscillators and a plurality of torsion springs, and wherein said oscillators and said torsion springs are disposed on a straight line along the oscillation central axis.

4. An oscillator device according to claim 1, wherein a gravity center of said magnetic material is disposed on the oscillation central axis of said oscillator.

5. An oscillator device according to claim 1, wherein said magnetic member has a cylindrical shape, and wherein the side portion of said oscillator has a recess.

6. An oscillator device according to claim 1, wherein said magnetic member is comprised of a permanent magnet, and wherein said magnetic-field generating member is comprised of an electric coil.

7. An optical deflector, comprising:
an oscillator device as recited in claim 1; and
a light reflecting member provided on one oscillator.

8. An oscillator device, comprising:
a supporting member;
a first resilient support member configured to connect a first oscillator and said supporting member each other and to support said first oscillator for oscillatory motion about an oscillation central axis;
a second resilient support member configured to connect the first oscillator and a second oscillator each other and to support said second oscillator for oscillatory motion about the oscillation central axis;
a magnetic member provided on said first oscillator; and
a magnetic-field generating member disposed opposed to said first oscillator;
wherein said magnetic member is provided at a side portion sandwiched between a top surface and a bottom surface of said first oscillator.

9. An optical instrument, comprising:
a light source;
an optical deflector as recited in claim 7; and
a target member on which light is to be incident;
wherein said optical deflector is configured to deflect light from said light source and to project at least a portion of the light onto said target member.
